(19) United States
(12) Patent Application Publication
(10) Pub. No.: US 2022/0017429 A1
(43) Pub. Date: Jan. 20, 2022

(54) MANUFACTURING METHOD OF ORGANIC FERTILIZER WITH PROTEINS AND HYDROLYSED AMINO ACIDS AND RESULTING ORGANIC FERTILIZER

(71) Applicant: Rafael Bortoli, Rondonopolis (BR)

(72) Inventor: Rafael Bortoli, Rondonopolis (BR)

(21) Appl. No.: 17/432,688

(22) PCT Filed: Jun. 24, 2019
(86) PCT No.: PCT/IB2019/055310

§ 371 Date: Aug. 20, 2021

(51) Int. Cl. C05F 1/00

(52) U.S. Cl. CPC C05F 1/002; C05F 1/02

(57) ABSTRACT

It is a manufacturing method (10) of organic fertilizer (FG) obtained from the disposal of fish such as carcasses and viscera; said manufacturing method (10) of organic fertilizer (FG) consists of two sequential operational stations, namely the feeding station (FT), which is connected to the controlled hydrolysis station (ETH) using a set of equipment (CP) fed by steam, compressed air, fuel gas, water-soluble lewis acid, drinking water stored in tanks, reservoirs, chiller, among other equipment used to obtain the organic fertilizer (FG).

### TECHNICAL FIELD OF THE INVENTION

The present invention patent deals with the manufacturing method of fertilizer with proteins and hydrolyzed amino acids whose raw material comes from fish waste such as carcasses and viscera; most notably, this method allows the obtaining of an efficient organic fertilizer for plant nutrition in diverse cultures based on the technique of enzymatic hydrolysis in association with acid hydrolysis, in order to take full advantage of the waste material, transforming it into part of an amino acid solution and another part into organic insolubles which, after a new acid hydrolysis, is incorporated into the final product.

### BACKGROUND OF THE INVENTION

It is known that fertilizers are of extreme importance in the market for increasing the supply of fruit and vegetables, as well as improvement of ornamental plants of gardening in general through the reduction of pests in various crops. Among the fertilizers used are organic ones derived from remains of organic matter or by-products of living organisms, such as fertilizers obtained from fish liabilities such as carcasses and viscera.

In the current state of the art, the production of fertilizers obtained from fish liabilities, carcasses and viscera uses conventional methods through fermentation processes, by means of bacteria and various compositions, a fact that greatly imposes the production cost, especially because the process time is substantially higher than the method now innovated, as will be seen later on.

Another inconvenience lies in the fact that the use of the discarded products is not integral, besides the process currently employed makes it impossible to control the activity and quality of the final product because it does not use process instrumentation and control technology.

Another aggravating factor is the short shelf life of the final product obtained through traditional processes, since, normally, these fertilizers do not inactivate the natural enzymes allowing a continuous decomposition and natural fermentation inside the commercial packaging, generating gases and microorganisms not identified and, consequently, the degradation of the fertilizer.

Another inconvenience lies in the fact that the manufacturing processes, because they do not present a controlled production process technique, usually do not achieve a final product standardization, containing particles of various sizes, rest of bones, scales and other insoluble solids, a fact that hinders the application in physical matters with stops due to clogging and incrustations of the spraying systems, thus increasing the application cost.

### STATE OF THE ART ANALYSIS

In a research carried out in specialized databases, documents were found referring to the fertilizer manufacture method obtained from fish discards, such as the document No. CN107915535 which deals with a fish protein fertilizer containing ‘bacillus subtilis’ and its manufacturing method. The fish protein fertilizer contains ‘bacillus subtilis’ and comprises, by mass, 1-6 parts of wetting agent, 10-90 parts of hydrolyzed fish protein and 1-10 parts of ‘bacillus subtilis’ spore powder. The ‘bacillus subtilis’ in spore powder is bacillus subtilis MBI600.

Document No. BR10.2016.011859-0 deals with the manufacturing process of organic fertilizer based on amino acids of animal dermal protein origin, which is intended for agriculture in general, and refers to a product that can be obtained in its liquid form or in powder, highlighting that the product obtained in the powder form is performed after the drying process, and the final product, obtained from the chemical/physical process, of digestion/thermal hydrolysis of animal leather, the following materials of animal origin, such as: kneeling powder, sawdust, scraps, trimmings, pickled scrapings and/or even pickled leather in its entire form; kneeling powder, sawdust, scraps, trimmings and scrapings tanned to vegetable tannin (acacia tannin or other vegetable extracts), and/or even leather tanned to vegetable tannin (acacia tannin or other vegetable extracts) in its entire form; and/or shavings and trimmings limed, being characterized by having Amino Acids, such as: Alanine; Glycine, Valine, Leucine, Isoleucine, Proline, Phenylalanine, Tyrosine, Serine, Threonine, Cystine (trace), Methionine (trace), Arginine, Histidine, Lysine, Aspartic Acid, Glutamic Acid, and others, as well as Nitrogen, Phosphorus and Potassium, and additional elements such as Calcium, Magnesium, Sulfur, Iron, Manganese, Copper, Zinc, Sodium and Boron.

Document No. CN105967761 deals with a method to produce a water-soluble fertilizer of amino acids and comprises the following steps:

A. Amino acid of the hydrolysing compound, namely the addition of alkaline protease liquid to the crude earthworm protein liquid left after the lumbricin is extracted to perform enzymolysis, the addition of acid protease and additional hydrolysis to prepare the hydrolyzed compound amino acid;

B. Carry out a chelation reaction, i.e. addition of ZnSO4.7H2O and Na2SeO3 to the compound amino acid hydrolysate to perform the chelation reaction to obtain compound amino acid chelate;

C. Separate and purify the amino acid chelate compound using an organic methanol or ethanol solvent, and then dry to obtain the water-soluble amino acid fertilizer.

Document No. PI 0505729-9 deals with the process of obtaining concentrated organic fertilizer produced from fresh marine fish and the resulting product, the liquefied fish passes through a sieve and is pumped into fermentation boxes where more molasses are added; the natural enzymatic fermentation process begins, where it will remain until it completes the total hydrolyzation of the fish, this process varies from 15 to 30 days; then this hydrolysate is sieved again, this time in a fine sieve and pumped into storage tanks.

The above documents, although belonging to the same field of application, differ from the present invention in question, as will be seen below, thus ensuring that it fully meets the legal requirements for patentability.

### OBJECTIVES OF THE INVENTION

The objective of this invention patent is to present a fertilizer manufacturing method with proteins and hydrolyzed amino acids, particularly obtained from fish discards such as carcasses and viscera, thus allowing the obtaining of an efficient organic fertilizer for plant nutrition in various cultures based on the technique of enzymatic hydrolysis in association with acid hydrolysis.

Another objective of the patent is to present a fertilizer manufacturing method with proteins and hydrolyzed amino acids obtained from fish discards with controlled hydrolysis whose process times are significantly shorter than the traditional fermentative processes, besides providing production in hydrolysis reactors with controlled instrumentation of temperature, pH, stirring and weight of the mass, obtaining soluble and insoluble phases and addition in formulation.

Another objective of this patent is to present a fertilizer manufacturing method with proteins and hydrolyzed amino acids obtained from fish discards whose decomposition stage is possible to take advantage of 100% of the discard material, turning them into 80% amino acid solution, and 20% and organic insoluble which after new acid hydrolysis is solubilized and incorporated into the final product.

It is also the objective of this patent to present a fertilizer manufacturing method with proteins and hydrolyzed amino acids obtained from fish discards whose stages of the method are safe for the operators involved through the autonomy of free contact with the raw materials and final product obtained.

The objective of this patent is to present a resulting organic fertilizer whose physical chemical characteristics revealed associated with quality control and application of the innovated method standard procedure, allows the obtaining of an organic fertilizer with compatibility with other chemical products and adjuvants.

Another objective of this patent is to present a resulting organic fertilizer whose physical characteristics in terms of application in the field do not cause fouling and clogging of the spraying systems, showing a significant cost reduction for the end customer.

It is also the objective of the patent to present a resulting organic fertilizer with higher concentrations of amino acids and other characteristics where a reduction in the amount of application and volume of product applied per area is achieved.

Another objective of this patent is to present improvements in the fertilizer manufacturing method with proteins/hydrolyzed amino acids obtained from fish discards and resulting organic fertilizer that contribute to the environment by reducing discards.

### DESCRIPTION OF THE FIGURES

To complement this description in order to obtain a better understanding of the features of this invention and in accordance with a preference for its practical implementation, a set of drawings is attached to this description, in which, in an exemplary but not limitative manner, its operation was represented:

FIG. 1 represents a schematic view of the feeding station of the fertilizer manufacturing method with proteins and hydrolyzed amino acids obtained from fish discards such as carcasses and viscera; and

FIG. 2 shows a schematic view of the controlled hydrolysis station for the completion of the innovative method.

### DESCRIPTION OF THE INVENTION

As regards the illustrated drawings, the present invention patent refers to the “MANUFACTURING METHOD OF ORGANIC FERTILIZER WITH PROTEINS AND HYDROLYSED AMINO ACIDS AND RESULTING ORGANIC FERTILIZER”, more precisely it is a manufacturing method (10) of organic fertilizer (FG) obtained from fish discards, such as carcasses and viscera.

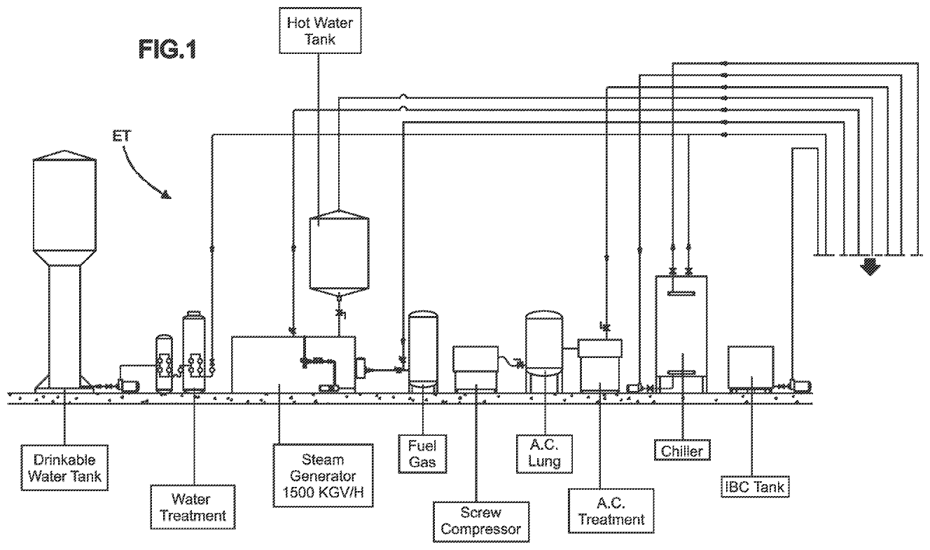

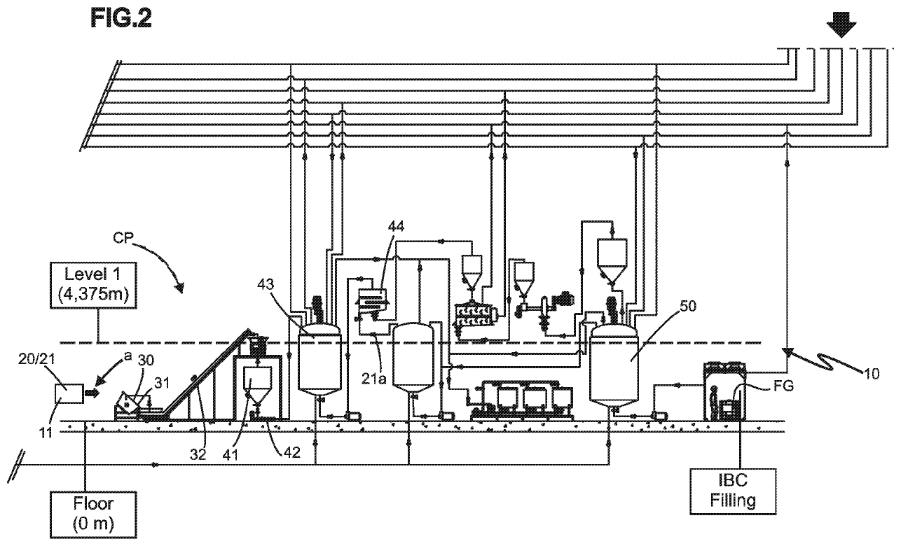

According to the present invention, the manufacturing method (10) of organic fertilizer (FG) is formed by two sequential operational stations, which are the feeding station (ET) (FIG. 1), which is connected to the controlled hydrolysis station (ETH) (FIG. 2) using a set of equipment (CP) fed by steam, compressed air, fuel gas, water-soluble lewis acids, drinking water stored in tanks, reservoirs, chiller, among other equipment used to obtain the organic fertilizer (FG).

The feeding station (ET) of this manufacturing method (10) of organic fertilizer (FG) has the following stages:
a) Storage and conveying of raw material, i.e., discards (20) of carcasses (21) of fish—In this stage the carcasses (21) are received in the unit in plastic boxes (11) with a volume of approximately 300 kg per unit. The boxes (11) are stored in cooled warehouse, with the necessary observations in relation to the state of conservation and guarantee of quality coming from them. These discarded boxes (20) are carried by forklift trucks to the tumbler assembly (30) of boxes (11), in an air-conditioned environment, where it unloads the fish carcasses into the material intake hopper, installed over the crusher (40). Said tumbler assembly (30) comprises tumbler (31) and conveyor belt (32);
b) Crushing of the carcass (21)—At this stage the crusher (40) standardizes the size of the particle (21a) to be hydrolyzed for efficiency of the enzymatic action and significant reduction of the process time. Said crushed material (21a) is then pumped directly to the hydrolysis reactor (43) through a helical pump (42) of crushed carcasses (21a), which is connected to a storage silo (41). Said hydrolysis reactor (43) is equipped with a load cell weighing system, preferably in the 50-90% carcass ratio. Then the water is added, proportionally in the order of 10-50% of the carcasses (21a) already transferred.

The processing/hydrolysis station (ETH) (FIG. 2), after complete loading of the crushed carcasses (21a) of fish and water, follows the order below: al) steam controlled temperature rise, considering as instantaneous parameter the temperature of the direct core, mass of the product. This stage raises the temperature starting from the ambient state from 10° C. to 20° C. until reaching the required parameter of 60° C., with the reactor (43) under constant stirring. The ratio for mass balance and time of this phase with scenario from 10° C. up to 60° C. is required approximately 1400 kgv/h, and the rise time is approximately 30 minutes. When the optimum product core temperature of 60° C. is reached with the reactor (43) constantly stirring after 5 minutes of operation, the condition of the PH is analyzed and displayed directly in a panel with the reactor's HMI (43) located on the operating floor. The PH value must be in the range of 6.0 to 9.0, and if it is in different parameters it is necessary to adjust it until it reaches ideal conditions, chemically executed through a lewis base to raise the range and or lewis acid to reduce the range;

b1) The proteolytic enzyme, previously weighed and diluted in non-chlorinated water, is added in the order of direct addition by the reactor receiving hopper (43), being 0.1-2.0% of the total weight of the raw material composed of viscera (22) and carcasses (21) counted in the reactor (43);

c1) After 10 minutes of process, sampling for process and control recording is initiated, with samples being taken every 30 minutes, totaling 7 samples, at 3:30 h of estimated hydrolysis process, and extra samples can be taken if necessary. The analyses that must be recorded reveal the parameters PH and Brix—% dissolved solids until reaching the ideal parameter of PH in range 6.0 to 7.0 and Brix of 10-18. When reached, a new cycle of temperature increase begins, starting from 60° C. of the process to 80° C., which is required for inactivation of the active enzymes. Starting from the scenario of 60° C. to 80° C., 1400kgv/h are required, and the rise time is about 20 minutes, waiting 20 minutes for the end of the inactivation cycle to make the transfer to the soluble and insoluble separation process by screening. Separation transfer/screening time of about 60 minutes;

d1) After the transfer through the vibratory classifier (44) and reaching the total hydrolyzed solution, keeping it homogenized by recycling process, keeps the solution in storage process for 20 minutes, for homogenization of the oily phases. The transfer to the final formulation reactor begins (50). The transfer time of the solution from the hydrolyzed reservoir (43) to the final formulation reactor (50) is 45 minutes, and the solution tends to reach the final formulation reactor (50) at a temperature of about 65° C., which should be reduced to 40° C., under constant stirring;

e1) Assessing the pH, the reactor (50) starts the adjustment process and should reach the ideal range of pH 3.0 to 5.0, in this case the automated addition of lewis acid. After 10 minutes of stirring the antioxidant and preservative are added. For the conclusion of the method (10), the rheology modifying suspending agent is added, preferably xanthan gum in the order of 0.35%, and the solution coming from the acid hydrolysis, obtained in the process so that it remains in suspension, besides other additives, such as minerals, carboxylic acids and other raw materials for preparation of the final product to be developed. For the reduction of temperature and final formulation considering already fractioned raw material the time is about 2 hours and 20 twenty minutes.

The resulting organic fertilizer (FG) using fish discards (20) such as carcasses (21) and viscera (22) employs a technique of enzymatic hydrolysis in association with acid hydrolysis benefiting 100% of the discarded material, converting it into 80% of amino acid solution and 20% of organic insolubles which, after micronized, incorporate organic fertilizer (FG).

The resulting organic fertilizer (FG), obtained from fish discards used in the method (10), includes proteins and hydrolyzed amino acids and physical characteristics that do not cause fouling.

It is certain that when the present invention is put into practice, modifications may be introduced with regard to certain details of construction and shape, without this implying a departure from the basic principles that are clearly substantiated in the claiming framework, it being understood that the terminology used did not have the purpose of limitation.

1. “MANUFACTURING METHOD OF ORGANIC FERTILIZER WITH PROTEINS AND HYDROLYSED AMINO ACIDS AND RESULTING ORGANIC FERTILIZER”, more precisely it is a manufacturing method (10) organic fertilizer (IG) obtained from the discarding of fish as carcasses and viscera; characterized by being the manufacturing method (10) of organic fertilizer (FG) formed by two sequential operational stations, which are the feeding station (ET), which is connected to the controlled hydrolysis station (ETH) using a set of equipment (CP) fed by steam, compressed air, fuel gas, water-soluble lewis acids, drinking water stored in tanks, reservoirs, chiller, among other equipment used to obtain the organic fertilizer (FG) where: the feeding station (ET) of this method (10) of organic fertilizer manufacturing (FG) presents the stages of:
a) Storage and conveying of raw material, i.e., discards (20) of carcasses (21) of fish—In this stage the carcasses (21) are received in the unit in plastic boxes (11) with a volume of about 300 kg per unit. The boxes (11) are stored in cooled warehouse, with the necessary observations in relation to the state of conservation and guarantee of quality coming from them. These discarded boxes (20) are carried by forklift trucks to the tumbler assembly (30) of boxes (11), in an air-conditioned environment, where it unloads the fish carcasses into the material intake hopper, installed over the crusher (40). Said tumbler assembly (30) comprises tumbler (31) and conveyor belt (32);
b) Crushing of the carcass (21)—At this stage the crusher (40) standardizes the size of the particle (21a) to be hydrolyzed for efficiency of the enzymatic action and significant reduction of the process time. Said crushed material (21a) is then pumped directly to the hydrolysis reactor (43) through a helical pump (42) of crushed carcasses (21a), which is connected to a storage silo (41). Said hydrolysis reactor (43) is equipped with a load cell weighing system, preferably in the 50-90% carcass ratio. Then the water is added, proportionally in the order of 10-50% of the carcasses (21a) already transferred; the transformation/hydrolysis station (ETH) (FIG. 2), after complete loading of the crushed carcasses (21a) of fish and water, follows the order below: a1) steam controlled temperature rise, considering as instantaneous parameter the temperature of the direct core, mass of the product. This stage raises the temperature starting from the ambient state from 10° C. to 20° C. until reaching the required parameter of 60° C., with the reactor (43) under constant stirring; the relation for mass balance and time of this phase with scenario from 10° C. to 60° C., is necessary about 1400 kgv/h, and the rise time is about 30 minutes; when the ideal temperature of the product core is reached at 60° C., with the reactor (43) in constant stirring, after 5 minutes of operation, the condition of the PH is analyzed, indicated directly in a panel with human-machine interface of the reactor (43) located on the operating floor; the PH value must be in the range of 6.0 to 9.0, and if it is in different parameters it is required to adjust it until it reaches ideal conditions, chemically executed through a lewis base to raise the range and or lewis acid to reduce the range;
b1) The proteolytic enzyme, previously weighed and diluted in non-chlorinated water, is added in the order of direct addition by the reactor receiving hopper (43), being 0.1-2.0% of the total weight of the raw material composed of viscera (22) and carcasses (21) counted in the reactor (43);
c1) After 10 minutes of process, sampling for process and control recording is initiated, with samples being taken every 30 minutes, totaling 7 samples, in the 3:30 h of estimated process of hydrolysis, being also able to make extra samples if necessary;
the analyses that must be registered reveal if the parameters of PH and Brix—% dissolved solids until reaching the ideal parameter of PH range 6.0 to 7.0 and Brix of 10-18; when reached starts a new cycle of increase of temperature, starting from 60° C. of the process to 80° C., this necessary for inactivation of the acting enzymes; Starting from the scenario of 60° C. to 80° C., 1400 kgv/h are required, and the rise time is about 20 minutes, waiting 20 minutes for the end of the inactivation cycle to make the transfer to the soluble and insoluble separation process by sieving; separation transfer/sieving time of about 60 minutes;
d1) After the transference by the vibratory classifier (44) and the total hydrolyzed solution is reached, keeping it homogenized by recycling process, the solution is kept in storage process for minutes, for homogenization of the oily phases; the transference to the final formulation reactor is initiated (50);
the transfer time of the solution from the hydrolyzed reservoir (43) to the final formulation reactor (50) is 45 minutes, and the solution tends to reach the final formulation reactor (50) at a temperature of about 65° C., which should be reduced to 40° C., under constant stirring;
e1) Assessing the pH, the reactor (50) starts the adjustment process and should reach the ideal range of pH 3.0 to 5.0, in this case the automated addition of lewis acid; after 10 minutes of stirring the antioxidant and preservative are added; for the conclusion of the method (10), the rheology modifying suspending agent is added, preferably xanthan gum in the order of 0.35%, and the solution coming from the acid hydrolysis, obtained in the process so that it remains in suspension, besides other additives, such as minerals, carboxylic acids and other raw materials for preparation of the final product to be developed; for the reduction of temperature and final formulation considering already fractioned raw material the time is about 2:20 h.

2. “RESULTING ORGANIC FERTILIZER”, according to claim 1, characterized by resulting organic fertilizer (FG) using discards (20) of fish as, carcasses (21) and viscera (22) employed technique of enzymatic hydrolysis in association with acid hydrolysis to benefit 100% of the waste material turning it into organic fertilizer (FG).

3. “RESULTING ORGANIC FERTILIZER”, according to claim 1, characterized by resulting organic fertilizer (FG), obtained from fish discards used in the method (10), includes proteins and hydrolyzed amino acids and physical characteristics that do not cause fouling.
